(19) United States
(12) Patent Application Publication
(10) Pub. No.: US 2018/0242588 A1
(43) Pub. Date: Aug. 30, 2018

(54) BIOCIDAL MIXTURES

(71) Applicant: LANXESS Deutschland GmbH, Cologne (DE)

(72) Inventors: Hermann UHR, Leverkusen (DE); Thomas JAETSCH, Cologne (DE)

(73) Assignee: LANXESS Deutschland GmbH, Cologne (DE)

(21) Appl. No.: 15/754,073

(22) PCT Filed: Aug. 31, 2016
(86) PCT No.: PCT/EP2016/070521

§ 371 Date: Feb. 21, 2018

(30) Foreign Application Priority Data
Sep. 2, 2015 (EP) 15183408.2
Feb. 24, 2016 (EP) 16157033.8

(51) Int. Cl. A01N 59/20; A01N 25/10; A01N 33/08; A01N 43/56; C08L 97/02; C08L 101/00; B27K 3/00; B27K 3/08; B27K 3/22; B27K 3/52; B27K 3/34; B27K 3/36

(52) U.S. Cl. CPC A01N 59/20; A01N 25/10; A01N 33/08; A01N 43/56; C08L 97/02; C08L 101/00; B27K 2240/20; B27K 3/08; B27K 3/22; B27K 3/52; B27K 3/343; B27K 3/36; B27K 3/007

(57) ABSTRACT

The invention relates to biocidal mixtures comprising penflufen-containing polymer particles, copper compounds and specific alkanolamines and to the use thereof for protecting wood and wood products, and also to wood preservatives comprising biocidal mixtures and optionally further active ingredients.

The invention relates to biocidal mixtures comprising penflufen-containing polymer particles, copper compounds and specific alkanolamines and to the use thereof for protecting wood and wood products, and also to wood preservatives comprising biocidal mixtures and optionally further active ingredients.

Penflufen (N-(2-[1,3-dimethylbutylphenyl]-5-fluoro-1,3-dimethyl-1H-pyrazole-4-carboxamide, CAS No. 494793-67-8) is an active fungicidal ingredient from the class of the pyrazolylcarboxanilides of the formula (I) and is known from WO 20031010149 A1.

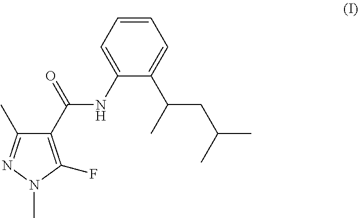 [SMILES: Cc1nn(C)c(F)c1C(=O)Nc1ccccc1C(C)CC(C)C]

In combination with further fungicidal, bactericidal, algicidal and insecticidal active ingredients, the spectrum of activity can be widened and can be adapted to the particular requirements. From WO 2012055673 A1 and WO 2012055674 A1 it is known that penflufen can be utilized in particular for controlling wood-destroying fungi.

Copper compounds are employed diversely in industrial wood preservation, owing to their spectrum of activity and their economy. Soluble copper compounds, insoluble copper compounds, and also micronized copper compounds, as known for example from US 2005/0118280 A1, are used. Examples of common soluble copper compounds are Cu-amine complexes, such as copper-monoethanolamine complexes. Furthermore, copper compounds are also used together with other active ingredients in order to broaden the spectrum of activity. U.S. Pat. No. 5,635,217, for example, discloses wood preservatives composed of azoles, copper compounds and alkanolamines that supply a good spectrum of activity. A disadvantage of these biocidal mixtures, however, is that large quantities of toxic azoles still have to be used.

There is therefore demand for an active ingredient combination which offers a high level of protection against wood-described fungi and allows the disadvantages of the prior art to be overcome.

Surprisingly, now, a biocidal mixture comprising penflufen-containing polymer particles, copper compounds and specific alkanolamines has been found that supplements the spectrum of activity and is more effective than when using unencapsulated penflufen in the presence of copper compounds and alkanolamines. Moreover, it is possible to do entirely without the additional use of azoles.

A subject of the invention is therefore a biocidal mixture comprising penflufen-containing polymer particles, at least one alkanolamine selected from the group consisting of monoalkylmonoamines, monoalkyldiamines, dialkylamines and trialkylamines, substituted by one, two or three hydroxyl groups, and at least one copper compound or copper-alkanolamine complexes thereof.

Copper compounds used in the biocidal mixtures of the invention may be water-soluble or waterinsoluble, organic or inorganic copper compounds or salts such as, for example and preferably, copper sulfate, copper acetate, copper carbonate, copper hydroxide, copper borate, copper fluoride, copper hydroxide carbonate, copper oxide and copper chloride. Preference is given to using water-soluble inorganic copper salts. Particularly preferred for use are copper hydroxide and copper hydroxide carbonate or mixtures of these compounds.

Alkanolamines used in the biocidal mixtures of the invention are monoalkylmonoamines, monoalkyldiamines, dialkylamines and trialkylamines substituted by one, two or three hydroxyl groups. Alkanolamines used for example and with preference are isopropanolamine, 1,1-diaminoethanol, 1,2-diaminoethanol, aminoethylethanolamine, diethanolamine, triethanolamine, methylethanolamine and monoethanolamine. Particularly preferred for use are C₁-C₈ monoalkylmonoamines. C₁-C₈ monoalkyldiamines and C₁-C₈ dialkylamines substituted by one or two hydroxyl groups. Very particular preference is given to using monoethanolamine.

Alkyl in the context of the invention is an unbranched or branched, linear or cyclic alkyl radical having 1 to 20 carbon atoms. Alkyl is preferably an unbranched or branched, linear or cyclic alkyl radical having 1 to 14 carbon atoms, very preferably having 1 to 8 carbon atoms.

For example and with preference, alkyl is methyl, ethyl, n-propyl, isopropyl, n-, iso-, s- or t-butyl, cyclopropyl, cyclobutyl, cyclopentyl, cyclohexyl, cycloheptyl, n-pentyl, 1-methylbutyl, 2 methylbutyl, 3-methylbutyl, neopentyl, 1-ethylpropyl, cyclohexyl, cyclopentyl, n-hexyl, n-heptyl, n-octyl, n-decyl and n-dodecyl.

The penflufen-containing polymer particles may be produced from polymer particles which have been produced from natural, semisynthetic and synthetic materials.

Natural materials which can be used in the context of the invention for the polymer particles include, for example, gum arabic, agar, agarose, maltodextrin, sodium alginate, calcium alginate, dextran, fats, fatty acids, cetyl alcohol, milk solids, molasses, gelatin, gluten, albumin, shellac, starches, caseinates, stearins, sucrose, and also waxes, such as beeswax, carnauba wax and spermaceti wax.

As semisynthetic materials for the polymer particles it is possible to use, for example, cellulose acetate, cellulose acetate butyrate, cellulose acetate phthalate, cellulose nitrate, ethylcellulose, hydroxypropylcellulose, hydroxypropylmethylcellulose, hydroxypropylmethylcellulose phthalate, methylcellulose, sodium carboxymethyl cellulose, hydrogenated tallow, myristyl alcohol, glycerol mono- or dipalmitate, hydrogenated castor oil, glyceryl mono- or tristearates and 12-hydroxystearyl alcohol.

As synthetic materials for the polymer particles it is possible to use, for example, amino resins, such as formaldehyde-melamine resins, formaldehyde-urea resins, formaldehyde-urea-melamine resins, polyurethanes, epoxy resins, styrene polymers and copolymers, acrylic polymers and copolymers, such as polyacrylamide, polyalkyl cyanoacrylate, and poly(ethylene-vinyl acetate), poly(styreneacrylamide), aluminum monostearate, carboxyvinylpolymers, polyamides, poly(methyl vinyl ether-maleic anhydride), poly(adipyl-L-lysine), polycarbonates, polyterephthalamide, poly(vinyl acetate phthalate), poly(terephthaloyl-L-lysine), polyarylsulfones, poly(methyl methacrylate), poly(ε-caprolactone), polyvinylpyrrolidone, polydimethylsiloxane, polyoxyethylenes, polypropylenes, polyesters, polyglycolic acid, polylactic acid and copolymers thereof, polyglutamic acid, polylysine, polyimines and polyvinyl alcohol or mixtures or copolymers thereof.

For the production of the natural, semisynthetic or synthetic polymer particles there are numerous methods known (see, for example, C. A. Finch, R. Bodmeier, Microencapsulation, Ullmann's Encyclopedia of Industrial Chemistry, 6th edition 2001, Electronic Release; D. Crespy, K. Landfester, Beilstein J. of Org. Chem. 2010, 6, 1132-1148). The penflufen-containing polymer particles can be produced by contacting the penflufen with the monomers even prior to the polymerization, before then carrying out polymerization. The particles may alternatively be produced by incorporating the penflufen into the polymer already present. This is done either by extrusion or by emulsifying a solution of the polymer and penflufen and removing the solvent (emulsion evaporation method). In a further embodiment, the penflufen may also be brought into contact with the finished polymer particles in order for adsorptive binding of the penflufen. In the penflufen-containing polymer particle, the penflufen may be surrounded by a polymer layer (conventional form of encapsulation) or else may be distributed evenly within the polymer (polymer matrix). Penflufen here can be present in undissolved, crystalline or amorphous form, in finely dispersed form, or in solution in the polymer. In the case of the solutions in the polymer, a term frequently used in the literature is that of “solidified solutions”, “solidified melts” or “polymer matrix”. Overall, intermediate forms are also encompassed and are also relatively probable, such as, for example, capsules wherein the penflufen in the core is surrounded by the polymer and yet peflufen is additionally still in the capsule shell, but also forms, where, for example, some of the penflufen is in solution in the polymer and another part of the penflufen in undissolved form is present in fine division in the polymer.

Penflufen may be employed as a racemate, in enantiomerically pure form or as an enriched enantiomer mixture. A use as salt or acid addition compound is also possible, salts being understood as meaning in particular sodium, potassium, magnesium, calcium, zinc, aluminum, iron and copper salts, and acid addition compounds being understood as meaning in particular adducts with hydrohalic acids, for example hydrogen chloride and hydrogen bromide, carboxylic acids such as, for example, formic acid, acetic acid, tartaric acid and oxalic acid, sulfonic acids such as, for example, p-toluenesulfonic acid, and also sulfuric acid, phosphoric acid and nitric acid. Preference is given to using penflufen.

The polymer of the penflufen-containing polymer particles consists preferably of styrene polymers and copolymers, and also acrylic polymers and copolymers. More preferably these are polyalkyl acrylates, polyalkyl methacrylates and copolymers of C₁-C₁₈ alkyl acrylates and C₁-C₁₈ alkylmethacrylates.

In general the penflufen-containing polymer particle contains 0.1% by weight to 30% by weight, preferably 0.2% by weight to 20% by weight and very preferably 0.5% by weight to 15% by weight, of penflufen, based on the total amount of penflufen-containing polymer particles. The polymer particles are preferably produced from polymers based on ethylenically unsaturated monomers.

The ethylenically unsaturated monomers may exist either as pure substances or as mixtures of a plurality of ethylenically unsaturated monomers.

Preference is given to neutral, uncharged, ethylenically unsaturated monomers which obtain the designation M1.

Suitable monomers M1 comprise preferably vinylaromatic monomers such as styrene, divinylbenzene, esters monoethylenically unsaturated monocarboxylic and dicarboxylic acids having 3 to 8 and more particularly 3 or 4 carbon atoms, with C₁-C₂₀ alkanols or with C₅-C₈ cycloalkanols, especially the esters of acrylic acid, of methacrylic acid, of crotonic acid, the diesters of maleic acid, of fumaric acid and of itaconic acid, and more particularly preferably the esters of acrylic acid with C₁-C₁₈ alkanols (C₁-C₁₈ alkyl acrylates) such as methyl acrylate, ethyl acrylate, n-butyl acrylate, isobutyl acrylate, tert-butyl acrylate, n-hexyl acrylate, 2-ethylhexyl acrylate, 3-propylheptyl acrylate and stearyl acrylate, and also the esters of methacrylic acid with C₁-C₁₈ alkanols, such as methyl methacrylate, ethyl methacrylate, n-butyl methacrylate, isobutyl methacrylate, tert-butyl methacylate, n-hexyl methacrylate and stearyl methacrylate. Further suitable monomers M1 are vinyl and allyl esters of aliphatic carboxylic acids having 1 to 20 carbon atoms, examples being vinyl acetate, vinyl propionate and also the vinyl esters of Versatic® acids (vinyl versatates), vinyl halides such as vinyl chloride and vinylidene chloride, conjugated diolefins such as butadiene and isoprene, and also C₂-C₆ olefins, such as ethylene, propene, 1-butene and n-hexene. Preferred monomers are vinylaromatic monomers, especially styrene, divinylbenzene, C₁-C₂₀ alkyl acrylates, especially C₁-C₁₈ alkyl acrylates and C₁-C₁₈ alkyl methacrylates or mixtures of these monomers.

Additionally suitable as monomers M1 are also amides of the aforesaid ethylenically unsaturated carboxylic acids, especially acrylamide and methacrylamide, ethylenically unsaturated nitriles such as methacrylonitrile and acrylonitrile, hydroxyalkyl esters of the aforesaid α,β-ethylenically unsaturated C₃-C₈ monocarboxylic acids and the C₄-C₈ dicarboxylic acids, especially hydroxyethyl acrylate, hydroxyethyl methacrylate, 2- and 3-hydroxypropyl acrylate, 2- and 3-hydroxypropyl methacrylate, esters of the aforementioned monoethylenically unsaturated monocarboxylic and dicarboxylic acids with C₂-C₄ polyalkylene glycols, especially the esters of these carboxylic acids with polyethylene glycol or alkyl-polyethylene glycols, in which case the (alkyl)polyethylene glycol radical customarily has a molecular weight in the range from 100 to 3000 g/mol.

Further monomers M1 are N-vinylamides such as N-vinylformamide, N-vinylpyrrolidone, N-vinylimidazole and N-vinylcaprolactam.

With preference the polymer is constructed from at least 60% by weight of monomers M1, based on the total amount of monomers used. With particular preference the fraction of monomers M1 is at least 70% by weight, very preferably at least 80% by weight.

Further to the monomers M1, it is optionally also possible for ethylenically unsaturated monomers having anionic or cationic groups to be copolymerized as well, in other words charged, ethylenically unsaturated monomers. The ethylenically unsaturated monomers having anionic or cationic groups obtain the designation M2.

The monomers M2 include, in particular, monoethylenically unsaturated monomers which have at least one anionic group, especially monomers which have at least one acid group, preferably at least one sulfonic acid group, one phosphonic acid group or one or two carboxylic acid groups, and also the salts of the monomers, especially the alkali metal salts, the sodium or potassium salts for example, and also the ammonium salts. Additionally, ethylenically unsaturated sulfonic acids, especially vinylsulfonic acid, 2-acrylamido-2-methylpopanesulfonic acid, 2-acryloyloxyethanesulfonic acid and 2-methacryloyloxyethanesulfonic acid, 3-acryloyloxy- and 3-methacryloyloxypropanesulfonic acid, vinylbenzenesulfonic acid and salts thereof, ethylenically unsaturated phosphonic acids such as vinylphosphonic acid and dimethyl vinylphosphonate and salts thereof, and α,β-ethylenically unsaturated C₃-C₈ monocarboxylic and C₄-C₈ dicarboxylic acids, especially acrylic acid, methacrylic acid, crotonic acid, maleic acid, fumaric acid and itaconic acid. Preferred for use as monomers M2 are α,β-ethylenically unsaturated C₃-C₈ monocarboxylic and C₄-C₈ dicarboxylic acids.

The monomers M2 may also include, in particular, monoethylenically unsaturated monomers which have at least one cationic group and/or at least one group which can be protonated in an aqueous environment. The cationic monomers M2 include, in particular, those which have a protonatable amino group, a quaternary ammonium group, a protontable imino group or a quaternized imino group. Examples of monomers M2 having a protonatable imino group are N-vinylimidazole and vinylpyridines. Examples of monomers M2 having a quaternized imino group are N-alkylvinylpyridinium salts and N-alkyl-N′-vinylimidazolinium salts such as N-methyl-N′-vinylimidazolinium chloride or methosulfate.

Examples of monomers M2 having protonatable amino groups are, for example and preferably, 2-(N,N-dimethylamino)ethyl acrylate, 2-(N,N-dimethylamino)ethyl methacrylate, 2-(N,N-dimethylamino)ethylacrylamide, 3-(N,N-dimethylamino)propylacrylamide, 3-(N,N-dimethylamino)propylmethacrylamide, 2-(N,N-dimethylamino)ethylmethacrylamide, which may be present for example in the form of Cl⁻, HSO₄⁻, ½SO₄²⁻ or CH₃OSO₃ salts. Monomers with quaternary ammonium compounds are, for example and preferably, 2-(N,N,N-trimethylammonium)ethyl acrylate chloride, 2-(N,N,N-trimethylammonium)ethyl methacrylate chloride, 2-(N,N,N-trimethylammonium)ethylmethacrylamide chloride, 3-(N,N,N-trimethylammonium)propylacrylamide chloride, 3-(N,N,N-trimethylammonium)propylmethacrylamide chloride, 2-(N,N,N-trimethylammonium)ethylacrylamide chloride, and also the corresponding methosulfates and sulfates.

The fraction of the monomers M2 is preferably not greater than 35% by weight, more preferably not greater than 20% by weight, based on the total amount of monomers used. Very particular preference is given to using 80% by weight to 99.9% by weight of monomers M1 and 0.1 weight % to 20 weight % of monomers M2, based on the total amount of monomers used.

In a further preferred embodiment, the amount of charged monomers M2 in the polymer is less than 0.01% by weight, based on the total amount of monomers used. The monomers are described above and can be employed individually or in a mixture.

The initiators suitable for the emulsion polymerization are the polymerization initiators commonly used and suitable for an emulsion polymerization that trigger a radical polymerization of the monomers M. They include oil-soluble azo compounds, such as 2,2′-azobisisobutyronitrile, 2,2′-azobis(2-methylbutyronitrile), 2,2′-azobis[2-methyl-N—(-2-hydroxyethyl)propionamide, 1,1′-azobis(1-cyclohexanecarbonitrile), 2,2′-azobis(2,4-dimethylvaleronitrile),2,2′-azobis(N,N′-dimethyleneisobutyroamidine) dihydrochloride, and 2,2′-azobis(2-amidinopropane) dihydrochloride, organic or inorganic peroxides such as diacetyl peroxide, di-tert-butyl peroxide, diamyl peroxide, dioctanoyl peroxide, didecanoyl peroxide, dilauroyl peroxide, dibenzoyl peroxide, bis(o toluoyl) peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butylperoxy 2-ethylhexanoate and diisopropyl peroxidicarbamate. It is likewise possible, however, to use water-soluble radical initiators, such as salts of peroxodisulfuric acid and redox initiator systems, for example, or cationic azo compounds, such as azobis(dimethylamidinepropane), for example. As water-soluble initiators it is possible to use the salts of peroxodisulfuric acid, especially sodium, potassium or ammonium salts, or a redox initiator system comprising as oxidizing agent a salt of peroxodisulfuric acid, hydrogen peroxide or an organic peroxide such as tert-butyl hydroperoxide. As reducing agents they preferably comprise a sulfur compound, selected more particularly from sodium hydrogensulfite, sodium hydroxymethanesulfinate and the adduct of hydrogen sulfite with acetone. Other suitable reducing agents are phosphorus-containing compounds such as phosphorous acid, hypophosphites and phosphinates, and also hydrazine or hydrazine hydrate and ascorbic acid. Moreover, redox initiator systems may include an addition of small amounts of redox metal salts such as iron salts, vanadium salts, copper salts, chromium salts or manganese salts, an example being the redox initiator system ascorbic acid/iron(II) sulfate/sodium peroxodisulfate.

Preference is given to using oil-soluble radical initiators. With very particular preference the radical initiators are 2,2′-azobisisobutyronitrile, 2,2′-azobis(2-methylbutyronitrile) or mixtures of these initiators.

Use may also be made, optionally, of further auxiliaries such as, for example, costabilizers, surface-active substances, such as protective colloids and low molecular weight emulsifiers, solvents and plasticizers. If auxiliaries are used, they are preferably costabilizers, emulsifiers and solvents.

The costabilizers optionally employed are substances which stabilze the microemulsion with respect to Ostwald ripening and have a very low solubility in the continuous phase. They are preferably long-chain, linear, cyclic or branched, aliphatic hydrocarbons selected from the group consisting of C₁₄-C₂₅ alkanes and C₁₄-C₂₅ cycloalkanes. More preferably they are C₁₄-C₁₈ alkanes and C₁₄-C₁₈ cycloalkanes, such as, with very particular preference, tetradecane, pentadecane, hexadecane, heptadecane, octadecane and nonadecane or mixtures of these costabilizers.

If costabilizers are used, the amount is in general between 0.05 to 20% by weight, preferably between 0.1 to 15% by weight and very preferably between 0.2 and 10% by weight, based on the total amount of monomers used.

Solvents and plasticizers used may in general by all substances which are inert with respect to the monomers, the resulting polymer and the penflufen.

Preferred solvents used are inert, dipolar, aprotic, organic solvents, such as, in particular, esters of dibasic carboxylic acids, as for example and preferably mixtures containing diisobutyl adipate, diisobutyl glutarate, diisobutyl succinate (e.g., Rhodiasolv DIB), and also benzyl alcohol, polyethylene glycols, polypropylene glycols.

Plasticizers used are preferably phthalates, such as, in particular, diethylbexyl phthalate (DEHP), dibutyl phthalate (BBP), diisononyl phthalate (DINP), diisodecyl phthalate (DIDP), diisooctyl phthalate (DNOP), diisobutyl phthalate (DIBP), diisohexyl phthalate, diisoeptyl phthalate, di-n-octyl phthalate, diisoundecyl phthalate, diisotredecyl phthalates; adipates, such as, in particular, diethylhexyl adipate (DEHA), diisooctyl adipate, diisononyl adipate, polyesters of adipic acid or glutaric acid, such as, in particular, Ultramoll IV® from Lanxess Deutschland GmbH; trialkyl esters of citric acid or acetylated trialkyl esters of citric acid, such as, in particular, acetyl tributyl citrate (ATBC); esters of trimellitic acid, such as, in particular, tri(2-ethylhexyl) trimellitate, tri(isooctyl) trimellitate, tri(isononyl) trimellitate; 1,2-dicyclohexyl-based plasticizers, such as, in particular, 1,2-cyclohexanedicarboxylic acid nonyl ester (Hexamoll®, DINCH); alkylsulfonic esters of phenol, such as, in particular, Mesamoll® from Lanxess Deutschland GmbH (CAS No. 091082-17-6); acetylated mono- and diglycerides; benzoic diesters, such as, in particular, dialkylene glycols, such as, in particular, dipropylene glycol dibenzoate or isononyl benzoate; trimethylolpropane esters such as, in particular, trimethylolpropane benzoate/2-ethylhexanoate mixtures; dialkyl esters of terephthalic acid, such as, in particular, di-2-ethylhexyl terephthalate.

Surface-active substances include not only protective colloids but also low molecular weight emulsifiers, the latter, in contrast to the protective colloids, preferably having a molecular weight of below 2000 g/mol, more particularly below 1000 g/mol (mass average). The protective colloids and low molecular weight emulsifiers may be cationic, anionic, neutral or else zwitterionic in nature.

Examples of anionic surface-active substances are anionic emulsifiers of low molecular weight such as—for example and preferably—alkylphenylsulfonates, phenylsulfonates, alkyl sulfates, alkylsulfonates, alkyl ether sulfates, alkylphenol ether sulfates, alkyl polyglycol ether phosphates, alkyldiphenyl ether sulfonates, polyaryl phenyl ether phosphates, alkylsulfosuccinates, olefinsulfonates, paraffinsulfonates, petroleumsulfonates, taurides, sarcosides, fatty acids, alkylnaphthalenesulfonic acids, naphthalenesulfonic acids, including their alkali metal, alkaline earth metal, ammonium and amine salts.

Anionic protective colloids are—for example and preferably—ligninosulfonic acids, condensation products of sulfonated naphthalenes with formaldehyde or with formaldehyde and phenol and optionally urea, and also condensation products of phenolsulfonic acid, formaldehyde and urea, lignin sulfite waste liquor and ligninosulfonates, and also polycarboxylates such as polyacrylates, maleic anhydride/olefin copolymers, and also the alkali metal, alkaline earth metal, ammonium and amine salts of the aforesaid protective colloids. Nonionic protective colloids are—for example and preferably—polyethylene glycol, polypropylene glycol, polyethylene glycol-polypropylene glycol block copolymers, polyethylene glycol alkyl ethers, polypropylene glycol alkyl ethers, polyethylene glycol-polypropylene glycol ether block copolymers and mixtures thereof.

Further protective colloids, of higher molecular weight, are—for example and preferably—carboxymethylcellulose, natural and synthetic polymers in powder, granule or latex form, such as gum arabic, polyvinyl alcohol, polyvinyl acetate, and also natural phospholipids, such as cephalins and lecithins, and synthetic phospholipid, and liquid paraffins.

Nonionic emulsifiers of low molecular weight are—for example and preferably—alkylphenol alkoxylates, alcohol alkoxylates, fatty amine alkoxylates, polyoxyethylene-glycerol fatty acid esters, castor oil alkoxylates, fatty acid alkoxylates, fatty acid amide alkoxylates, fatty acid polydiethanolamides, lanolin ethoxylates, fatty acid polyglycol esters, isotridecyl alcohol, fatty acid amides, methylcellulose, fatty acid esters, silicone fluids, alkyl polyglycosides and glycerol fatty acid esters.

Cationic emulsifiers of low molecular weight are—for example and preferably—quaternary ammonium salts, e.g., trimethyl- and triethyl-C₅-C₃₀ alkylammonium salts, such as cocotrimethylammonium salts, trimethylcetylammonium salts, dimethyl- and diethyldi-C₄-C₂₀ alkylammonium salts, such as didecyldimethylammonium salts and dicocodimethylammonium salts, methyl- and ethyl-tri-C₄-C₂₀ alkylammonium salts, such as methyltrioctylammonium salts, C₁-C₂₀-alkyl-di-C₁-C₄ alkylbenzylammonium salts, such as triethylbenzylammonium salts and cocobenzyldimethylammonium salts, hexadecyltrimethylammonium salts, methyl- and ethyldi-C₄-C₂₀-alkylpoly(oxyethyl)ammonium salts, e.g., didecylmethylpoly(oxyethyl)ammonium salts, N—C₆-C₂₀-alkylpyridinium salts, e.g., N-laurylpyridinium salts, N-methyl- and N-ethyl-N C₆-C₂₀-alkylmorpholinium salts, and also N-methyl- and N-ethyl-N′—C₆-C₂₀-alkylimidazolinium salts, especially the halides, borates, carbonates, formates, acetates, propionates, hydrogencarbonates, sulfates and methosulfates.

Zwitterionic emulsifiers of low molecular weight are those having betainic structures. Substances of this kind are known to the skilled person and may be found in the relevant prior art (see, for example, R. Heusch, in Ullmann's Encyclopedia of Industrial Chemistry, 5th edn. On CD-ROM, Wiley-VCH 1997, “Emulsions”, chapter 7, table 4).

The amount of low molecular weight emulsifier is customarily in the range from 0.1% by weight to 15% by weight, more particularly in the range from 0.2% by weight to 12% by weight and with especial preference 0.7% by weight to 10% by weight, based on the total amount of monomers used.

In order to increase the activity, but also in order to preserve the resultant suspensions, the penflufen-containing polymer particles may optionally further comprise antimicrobial compounds, fungicides, bactericides, herbicides, insecticides or other active ingredients. These mixtures may possess an even broader spectrum of activity. Like the penflufen, these compounds may be dissolved in the monomers or used in dispersed form. In many cases, synergistic effects are obtained, i.e. the activity of the mixture is greater than the activity of the individual components. Particularly favorable co-components or biocides are, for example, the following compounds:

triazoles such as:

azaconazole, azocyclotin, bitertanol, bromuconazole, cyproconazole, diclobutrazole, difenoconazole, diniconazole, epoxyconazole, etaconazole, fenbuconazole, fenchlorazole, fenethanil, fluquinconazole, flusilazole, flutriafol, furconazole, hexaconazole, imibenconazole, ipconazole, isozofos, myclobutanil, metconazole, paclobutrazole, penconazole, propioconazole, prothioconazole, simeoconazole, (+)-cis-1-(4-chlorophenyl)-2 (1H-1,2,4-triazol-1-yl)cycloheptanol, 2-(1-tert-butyl)-1-(2-chlorophenyl)-3-(1,2,4-triazol-1-yl)propan-2-ol, tebuconazole, tetraconazole, triadimefon, triadimenol, triapenthenol, triflumizole, tridconazole, uniconazole, and their metal salts and acid adducts;

imidazoles such as:

clotrimazole, bifonazole, climbazole, econazole, fenapamil, imazalil, isoconazole, ketoconazole, lombazole, miconazole, pefurazoate, prochloraz, triflumizole, thiazolcar 1-imidazolyl-1 (4′-chlorophenoxy)-3,3-dimethylbutan-2-one, and metal salts and acid adducts thereof;

pyridines and pyrimidines such as:

ancymidol, buthiobate, fenarimol, mepanipyrin, nuarimol, pyroxyfur, triamirol;

succinate dehydrogenase inhibitors such as:

benodanil, carboxim, carboxim sulfoxide, cyclafluramid, fenfuram, flutanil, furcarbanil, furmecyclox, mebenil, mepronil, methfuroxam, metsulfovax, nicobifen, pyrocarbolid, oxycarboxin, shirlan, Seodvax;

naphthalene derivatives such as:

terbinafine, naftifine, butenafine, 3-chloro-7-(2-aza-2,7,7-trimethyloct-3-en-5-yne);

sulfenamides such as:

dichiofluanid, tolylfluanid, folpet, fluorofolpet, captan, captofol;

benzimidazoles such as:

carbendazim, benomyl, fuberidazole, thiabendazole or their salts;

morpholine derivatives such as:

aldimorph, dimethomorph, dodemorph, falimorph, fenpropidin fenpropimorph, tridemorph, trimorphamid and the arylsulfonate salts thereof, for example p-toluenesulfonic acid and p-dodecylphenylsulfonic acid;

benzothiazoles such as:

2-mercaptobenzothiazole;

benzothiophene dioxides such as:

N-cyclohexylbenzo[b]thiophene-S,S-dioxide carboxamide;

benzamides such as:

2,6-dichloro-N-(4-trifluoromethylbenzyl)benzamide, tecloftalam;

boron compounds such as:

boric acid, boric acid esters, borax;

formaldehyde and formaldehyde donor compounds such as:

benzyl alcohol mono(poly)hemiformal, 1,3-bis(hydroxymethyl)-5,5-dimethylimidazolidine-2,4-diones (DMDMH), bisoxazolidines, n-butanol hemiformal, cis-1-(3-chloroallyl)-3,5,7-triaza-1 azoniaadamantane chloride, 1-[1,3-bis(hydroxymethyl-2,5-dioxoimidazolidin-4-yl]-1,3-bis(hydroxymethyl)urea, dazomet, dimethylolurea, 4,4-dimethyloxazolidines, ethylene glycol hemiformal, 7-ethylbicyclooxazolidines, hexahydro-S-triazines, hexamethylenetetramine, N-hydroxymethyl-N′-methylthiourea, methylenebismorpholine, sodium N-(hydroxymethyl)glycinate, N-methylolchloroacetamide, oxazolidines, paraformaldehyde, tauroline, tetrahydro-1,3-oxazine, N-(2-hydroxypropyl)amine methanol, tetramethylolacetyienediurea (TMAD);

isothiazolinones such as:

N-methylisothiazolin-3-one, 5-chloro-N-methylisothiazolin-3-one, 4,5-dichloro-N-octylisothiazolin-3-one, 5-chloro-N-octylisothiazolinone, N-octylisothiazolin-3-one, 4,5-trimethyleneisthiazolinone, 4,5-benzisotiazolinone;

aldehydes such as:

cinnamaldehyde, formaldehyde, glutardialdehyde, β-bromocinnamaldehyde, o-phthaldialdehyde;

thiocyanates such as:

thiocyanatomethylthiobenzothiazole, methylene bisthiocyanate;

quaternary ammonium compounds and guanidines such as:

benzalkonium chloride, benzyldimethyltetradecylammonium chloride, benzyldimethyldodecylammonium chloride, dichlorobenzyldimethylalkylammonium chloride, didecyldimethylammonium chloride, dioctyldimethylammonium chloride, N-hexadecyltrimethylammonium chloride, 1-hexadecylpyridinium chloride, iminoctadine tris(albesilate);

phenols such as:

tribromophenol, tetrachlorophenol, 3-methyl-4-chlorophenol, 3,5-dimethyl-4-chlorophenol, dichlorphene, 2-benzyl-4-chlorophenol, triclosan, diclosan, hexachlorophene, methyl p-hydroxybenzoate, ethyl p-hydroxybenzoate, propyl p-hydroxybenzoate, butyl p-hydroxybenzoate, octyl p-hydroxybenzoate, o-phenylphenol, m-phenylphenol, p-phenylphenol, 4-(2-tert-butyl-4-methylphenoxy)phenol, 4-(2-isopropyl-4-methylphenoxy)phenol, 4-(2,4-dimethylphenoxy)phenol and the alkali metal and alkaline earth metal salts thereof;

microbicides having an activated halogen group such as:

bronopol, bronidox, 2-bromo-2-nitro-1,3-propanediol, 2-bromo-4′-hydroxyacetophenone, 1-bromo-3-chloro-4,4,5,3-tetramethyl-2-imidazolidinone, β-bromo-β-nitrostyrene, chloroacetamide, chloramin T, 1,3-dibromo-4,4,5,5-tetramethyl-2-imidazolidinon, dichloramin T, 3,4-dichloro-(3H)-1,2-dithiol-3-one, 2,2-dibromo-3-nitrilepropionamide, 1,2-dibromo-2,4-dicyanobutane, halane, halazone, mucochloric acid, phenyl 2-chlorocyanovinyl sulfone, phenyl 1,2-dichloro-2-cyanovinyl sulfone, trichloroisocyanuric acid;

pyridines such as:

1-hydroxy-2-pyridinethione (and their Cu—, Na, Fe, Mn, Zn salts), tetrachloro-4-methylsulfonylpyridine, pyrimethanol, mepanipyrim, dipyrithione, 1-hydroxy-4-methyl-6-(2,4,4-trimethylpentyl)-2(1H)-pyridine;

methoxyacrylates or the like, such as:

azoxystrobin, dimoxystrobin, fluoxastrobin, kresoxim-methyl, metominostrobin, orysastrobin, picoxystrobin, pyraclostrobin, trifloxystrobin, 2,4-dihydro-5-methoxy-2-methyl-4-[2-[[[[1-[3-(trifluoromethyl)phenyl]ethylidene]amino]oxy]methyl]phenyl]-3H-1,2,4-triazol-3-one (CAS No. 185336-79-2);

metal soaps such as:

salts of the metals tin, copper and zinc with higher fatty acids, resin acids, naphthenoic acids and phosphoric acid, for example tin naphthenate, tin octoate, tin 2-ethylhexanoate, tin oleate, tin phosphate, tin benzoate, copper naphthenate, copper octoate, copper 2-ethylhexanonte, copper oleate, copper phosphate, copper benzoate, zinc naphthenate, zinc octoate, zinc 2-ethylhexanoate, zinc oleate, zinc phosphate, zinc benzoate;

metal salts such as:

salts of the metals tin, copper, zinc, and also chromates and dichromates, for example copper hydroxycarbonate, sodium dichromate, potassium dichromate, potassium chromate, copper sulfate, copper chloride, copper borate, zinc fluorosilicate, copper fluorosilicate;

oxides such as:

oxides of the metals tin, copper and zinc, such as, for example, tributyltin oxide, Cu₂O, CuO, ZnO;

oxidizing agents such as:

hydrogen peroxide, peracetic acid, potassium persulfate;

dithiocarbamates such as:

cufraneb, ferban, potassium N-hydroxymethyl-N′-methyldithiocarbamate, sodium dimethyldithiocarbamate, potassium dimethyldithiocarbamate, mancozeb, maneb, metam, metiram, thiram, zineb, ziram;

nitriles such as:

2,4,5,6-tetrachloroisophthalodinitrile, disodium cyanodithioimidocarbamate;

quinolines such as:

8-hydroxyquinoline and Cu salts thereof;

other fungicides and bactericides such as:

bethoxazin, 5-hydroxy-2(5H)furanone, 4,5-benzodithiazolinone, 4,5-trimethyleoedithiazolinone, N-(2-p-chlorobenzoylethyl)hexaminium chloride, 2-oxo-2-(4-hydroxyphenyl)acetohydroximic chloride, tris-N-(cyclohexyldiazeniumdioxy)aluminum, N-(cyclohexyldiazeniumdioxy)tributyltin or potassium salts thereof, bis-N-(cyclobexyldiazeniumdioxy)copper, iprovalicarb, fenhexamide, spiroxamine, carpropamid, diflumetorin, quinoxyfen, famoxadone, polyoxorim, acibenzolar S-methyl, furametpyr, thifluzamide, methalaxyl-M, benthiavalicarb, metrafenone, cyflufenamid, tiadinil, tea tree oil, phenoxyethanol,

Ag, Zn or Cu-containing zeolites alone or incorporated into polymeric materials.

Especially preferred are mixtures with

azaconazole, bromuconazole, cyproconazole, dichlobutrazole, diniconazole, diuron, hexaconazole, metaconazole, penconazole, propiconazole, tebuconazole, dichiofluanid, tolylfluanid, fluorfolpet, methfuroxam, carboxin, benzo[b]thiophene S,S-dioxide-carboxylic acid cyclohexylamide, fenpiclonil, 4-(2,2-difluoro-1,3-benzodioxol-4-yl)-1H-pyrrole-3-carbonitrile, butenafin, imazalil, N-methylisothiazolin-3-one, 5-chloro-N-methylisothiazolin-3-one, N-octylisothiazolin-3-one, dichloro-N-octylisozhiazolinone, mercaptobenzthiazole, thiocyanatomethylthiobenzthiazole, thiabendazole, benzisothiazolinone, N-(2-hydroxypropyl)aminomethanol, benzyl alkohol (hemi)formal, N-methylolchloroacetamide, N-(2-hydroxypropyl)aminemethanol, glutaraidehyde, omadine, Zn omadine, dimethyl dicarbonate, 2-bromo-2-nitro-1,3-propanediol, bethoxazine, o-phthaldialdehyde, 2,2-dibromo-3-nitrilepropionamide, 1,2-dibromo-2,4-dicyanobutane, 1,3-bis(hydroxymethyl)-5,5-dimethylimidazolidine-2,4-diones (DMDMH), tetramethylolacetylenediurea (TMAD), ethylene glycol hemiformal, p-hydroxybenzoic acid, carbendazim, chlorophene, 3-methyl-4-chlorophenol, o-phenylphenol.

Apart from with the abovementioned fungicides and bactericides, mixtures with a good efficacy are, moreover, also prepared with other active ingredients;

Insecticides/acaricides/nematicides:

abamectin, acephate, acetamiprid, acetoprole, acrinathrin, alanycarb, aldicarb, aldoxycarb, aidrin, allethrin, alpha-cypermethrin, amidoflumet, amitraz, avermectin, azadirachtin, azinphos A, azinphos M, azocyclotin,

Bacillus thuringiensis, barthrin, 4-bromo-2(4-chlorophenyl)-1-(ethoxymethyl)-5-(trifluoromethyl)-1H-pyrrole-3-carbonitrile, bendiocarb, benfuracarb, bensultap, betacyfluthrin, bifenthrin, bioresmethrin, bioallethrin, bistrifluron, bromophos A, bromophos M, bufencarb, buprofezin, butathiophos, butocarboxin, butoxycarboxim,

cadusafos, carbaryl, carbofuran, carbophenothion, carbosulfan, cartap, quinomethionate, cloethocarb, chlordane, chlorethoxyfos, chlorfenapyr, chlorfenvinphos, chlorfluazuron, chlormephos, N-[(6-chloro-3-pyridinyl)methyl]-N′-cyano-N-methylethaneimidamide, chlorpicrin, chlorpyrifos A, chlorpyrnfos M, cis-resmethrin, clocythrin, clothiazoben, cypophenothin clofentezin, coumaphos, cyanophos, cycloproibrin, cyfluthrin, cyhalothrin, cyhexatin, cypermethrin, cyromazin,

decamethrin, deltamethrin, demeton M, demeton S, demeton-S-methyl, diafenthiuron, dialiphos, diazinon, 1,2-dibenzoyl-1(1,1-dimethyl)hydrazine, DNOC, dichlofenthion, dichlorvos, dicliphos, dicrotophos, difethialone, diflubenzuron, dimethoate, 3,5-dimethylphenyl methylcarbamate, dimethyl(phenyl)silylmethyl-3-phenoxybenzyl ether, dimethyl(4-ethoxyphenyl)silylmethyl-3-phenoxybenzyl ether, dimethylvinphos, dioxathion, disulfoton,

eflusilanate, emamectin, empenthrin, endosulfan, EPN, esfenvalerate, ethiofencarb, ethion, ethofenprox, etrimphos, etoxazole, etobenzanid,

fenamiphos, fenazaquin, fenbutatin oxide, fenfluthrin, fenitrothion, fenobucarb, fenothiocarb, fenoxycarb, fenpropathrin, fenpyrad, fenpyroximate, fensulfothion, fenthion, fenvalerate, fipronil, flonicamid, fluacrypyrim, fluazuron, flucycloxuron, flucythrinate, flufenerim, flufenoxuron, flupyrazofos, flufenzine, flumethrin, flufenprox, fluvalinate, fonophos, formethanate, formothion, fosmethilan, fosthiazate, fubfenprox, furathiocarb

halofenozide, HCH (CAS RN: 58-89-9), heptenophos, hexaflumuron, hexythiazox, hydramethylnon, hydroprene,

imidaclopuid, imiprothrin, indoxycarb, iprinomectin, iprobenfos, isazophos, isoamidophos, isofenphos, isoprocarb, isoprothiolane, isoxathion, ivermectin,

kadedrin,

lambda-cyhalothrin, lufenuron,

malathion, mecarbam, mervinphos, mesulfenphos, metaldehyde, methacrifos, methamidophos, methiduthion, methiocarb, methomyl, metalcarb, milbemectin, monocrotophos, moxiectin,

naled, NI 125, nicotine, nitenpyram, noviflumuron,

omethoate, oxamyl, oxydemethon M, oxydeprofos,

parathion A, parathion M, penfluron, permethrin, 2-(4-phenoxyphenoxy)ethyl ethylcarbamate, phenthoate, phorate, phosalon, phosmet, phosphamidon, phoxim, pirimicarb, pirimiphos M, pirimiphos A, prallethrin, profenophos, promecarb, propaphos, propoxur, prothiophos, prothoate, pymetrozin, pyrachlophos, pyridaphenthion, pyresmethrin, pyrethrum, pyridaben, pyridalyl, pyrimidifen, pyriproxifen, pyrithiobac-sodium,

quinalphos,

resmethrin, rotenon,

salithion, sebufos, silafluofen, spinosad, spirodiclofen, spiromesifen, sulfotep, sulprofos,

Tau-fluvalinate, tar oils, tebufenozide, tebufenpyrad, tebupirimiphos, teflubenzuron, tefluthrin, temephos, terbam, terbufos, tetrachlorvinphos, tetramethrin, tetramethacano, thiacloprid, thiafenox, thiamethoxam, thiapronil, thiodicarb, thiofanox, thiazophos, thiocyclam, thiomethon, thionazin, thuringiensin, tralomethrin, transfluthrin, triarathene, triazophos, triazamate, triazuron, trichlorfon, triflumuron, trimethacarb,

vamidothion, xylylcarb, zetamethrin;

molluscicides

fentin acetate, metaldehyde, methiocarb, niclosamide;

herbicides and algicides:

acetochlor, acifluorfen, aclonifen, acrolein, alanchlor, alloxydim, ametryn, amidosulfuron, amitrole, ammonium sulfamate, anilofoas, asulam, atrazine, azafenidin, aziptrotryn, azimsulfuron,

benazolin, benfluralin, benfuresat, bensulfuron, bensulfid, bentazon, benzofencap, benzthiazuron, bifenox, bispyribac, bispyribac-sodium, borax, bromacil, bromobutide, bromofenoxim, bromoxynil, butachlor, butamifos, butralin, butylate, bialaphos, benzoyl-prop, bromobutide, butroxydim,

carbetamid, carfentrazone-ethyl, carfenstrol, chlomethoxyfen, chloramben, chlorbromuron, chloroflurenol, chloridazon, chlorimuron, chlornitrofen, chloroacetic acid, chloransulam-methyl, cinidon-ethyl, chlorotoluron, chloroxuron, chlorpropham, chlorsulfuron, chlorthal, chlorthiamid, cinmethylin, cinofulsuron, clefoxydim, clethodim, clomazone, chlomeprop, clopyralid, cyanamide, cyanazine, cycloate, cycloxydim, chloroxynil, clodinafop-propargyl, cumyluron, clometoxyfen, cyhalofop, cyhalofop-butyl, clopyrasuluron, cyclosulfamuron,

diclosulam, dichlorprop, dichlorprop-P, diclofop, diethatyl, difenoxuron, difenzoquat, diflufenican, dlflufenzopyr, dimefuron, dimepiperate, dimethachlor, dimethipin, dinitramine, dinoseb, dinoseb acetate, dinoterb, diphenamid, dipropetryn, diquat, dithiopyr, diduron, DNOC, DSMA, 2,4-D, daimuron, dalapon, dazomet, 2,4-DB, desmedipham, desmetryn, dicamba, dichiobenil, dimethamid, dithiopyr, dimethametryn,

eglinazin, endothal, EPTC, esprocarb, ethalfluralin, ethidimuron, ethofumesat, ethobenzanid, ethoxyfen, ethametsulfuron, ethoxysulfuron,

fenoxaprop, fenoxaprop-P, fenuron, flamprop, flamprop-M, flazasulfuron, fluazifop, fluazifop-P, fuenachlor, fluchloralin, flufenacet flumeturon, fluorocglycofen, fluoronitrofen, flupropanate, flurenol, fluridone, flurochloridone, fluroxypyr, fomesafen, fosamine, fosametine, flamprop-isopropyl, flamprop-isopropyl-L, flufenpyr, flumiclorac-pentyl, flumipropyn, flumioxzim, flurtamon, flumioxzim, flupyrsulfuron-methyl, fluthiacet-methyl,

glyphosates, glufosinate-ammonium

haloxyfop, hexazinone,

imazamethabenz, isoproturon, isoxaben, isoxapyrifop, imazapyr, imazaquin, imazethapyr, ioxynil, isopropalin, imazosulfuron, imazomox, isoxaflutole, imazapic,

ketospiradox,

lactofen, lenacil, linuron,

MCPA, MCPA hydrazide, MCPA-thioethyl, MCPB, mecoprop, mecoprop-P, mefenacet, mefluidid, mesosulfuron, metam, metamifop, metamitron, metazachlor, methabenzthiazuron, methazole, methoroptryne, methyldymron, methyl isothiocyanate, metobromuron, metoxuron, metribuzin, metsulfuron, molinate, monalid, monolinuron, MSMA, metolachlor, metosulam, metobenzuron.

naproanilide, napropamide, naptalam, neburon, nicosulfuron, norflurazone, sodium chlorate,

oxadiazone, oxyfluorfen, oxysulfuron, orbencarb, oryzalin, oxadargyl,

propyzamide, prosulfocarb, pyrazolates, pyrazolsulfuron, pyrazoxyfen, pyribenzoxim, pyributicarb, pyridat, paraquat, pebulat, pendimethalin, pentachlorophenol, pentoxazon, pentanochlor, petroleum oils, phenmedipham, picloram, piperophos, pretilachlor, primisulfuron, prodiamine, profoxydim, prometryn, propachlor, propanil, propaquizafob, propazine, propham, propisochlor, pyriminobac-methyl, pelargonic acid, pyrithiobac, pyraflufen-ethyl,

quinmerac, quinocloamine, quizalofop, quizalofop-P, quinchlorac,

rimsulfuron

sethoxydim, sifuron, simazine, simetryn, sulfosulfuron, sulfometuron, sulfentrazone, sulcotrione, sulfosate,

tar oils, TCA, TCA-sodium, tebutam, tebuthiuron, terbacil, terbumeton, terbutylazine, terbutryn, thiazafluron, thifensulfuron, thiobencarb, thiocarbazil, tralkoxydim, triallate, triasulfuron, tribenuron, triclopyr, tridiphane, trietazine, trifluralin, tycor, thidiazimin, thiazopyr, triflusulfuron, vernolate, thidiazimin, thiazopyr, triflusulfuron, vernolate.

Penflufen-containing polymer particles are preferably produced in a radical oil-in-water emulsion polymerization wherein at least one ethylenically unsaturated monomer is polymerized in the presence of penflufen or its salts and acid addition compounds and in the presence of a radical initiator.

The penflufen-containing polymer particles are customarily produced by first preparing an emulsion. In general, in order to prepare this emulsion, first the monomers and penflufen or salts and acid addition compounds thereof are mixed, optionally in the presence of further auxiliaries. The addition in that case may be made such that the entire amount of the monomers and of the penflufen are added to the aqueous solution in one step. Alternatively, the addition may take place with metering. In the case of the metered addition, the addition takes place in general at least over a period of 0.5 h. Preferably the addition takes place within a period of 0.5 to 5 hours. Optionally a neutral pH is set. The oil-in-water emulsion comprising monomers, penflufen and optionally low molecular weight emulsifiers, protective colloids and costabilizers is generally converted into an emulsion with particles of the desired size, in a process involving high shearing forces being generated. In order to generate high shearing forces, it is general practice to use rotor-stator systems such as Ultraturrax, ultrasound, high-pressure dispersers or nozzle assemblies through which the flow is axial. Customarily then the radical initiator is added. However, the radical initiator may equally well have been added to the mixture of monomers and penflufen before the mixture is emulsified. In general the resultant emulsion is then heated. The heated emulsion is customarily stirred further for a period of 1 to 20 hours, preferably 8 to 15 hours. The resultant suspension of penflufen-containing polymer particles is generally not in need of any further processing. However, the penflufen-containing polymer particles can also be isolated and dried and then processed further. Isolation of the penflufen-containing polymer particles may be accomplished, for example, by filtration and evaporation of the water, in a spray dryer, for example. If the pH needs to be set within the process of producing the penflufen-containing microcapsules, the pH is in that case set customarily using alkali metal salts of carbonates, hydrogencarbonates, phosphates, hydrogenphosphates, dihydrogenphosphates, citrates, or by using alkali metal compounds of weak organic acids.

The penflufen-containing polymer particles are preferably produced in a way which involves first introducing the aqueous solution, preferably containing low molecular weight emulsifiers. A further mixture, which comprises the monomers and the active ingredients, especially penflufen, and optionally further auxiliaries, and radical, oil-soluble initiators, is then added to the aqueous solution, either in metered form or else substantially in one amount. Then, preferably, the radical, oil-soluble initiator is added. The emulsion thereafter is preferably emulsified with high shearing forces in order to arrive at the desired particle size. The emulsion is preferably then heated and stirred for a further period of preferably 8 to 15 hours. The aqueous suspension of the penflufen-containing polymer particles is preferably then processed to give the biocidal mixtures of the invention.

The polymerization takes place in general at temperatures between 50° C. and 90° C. The polymerization may alternatively be carried out at higher or lower temperatures. The polymerization preferably takes place at 60° C. to 80° C.

In general, 0.1% by weight to 30% by weight, preferably 0.2% by weight to 20% by weight and very preferably 0.5 mol by weight to 15% by weight of penflufen is used, based on the total amount of the monomers, in the process for producing the penflufen-containing polymer particles.

The molecular weights of the penflufen-containing polymer particles may vary within a very wide range; they preferably have a molar mass of 10 000 to 100 000 g/mol.

The penflufen-containing polymer particles customarily have an average particle diameter of less than 1.5 μm, preferably of 20 nm to 1 μm, more preferably 50 nm to 600 nm. The average particle diameter is determined by laser diffraction according to ISO 13320-1.

If reference is made to an oil phase within the patent application, the reference in that case is to the phase in which the substantially waterinsoluble compounds used have undergone mutual dissolution. The oil phase generally contains the monomer or monomers, penflufen, radical oil-soluble initiator, optionally a costabilizer, optionally further active ingredients, and optionally further auxiliaries.

The water phase generally contains one or more emulsifiers and/or protective colloids and optionally salts and radical scavengers, which are intended to prevent the polymerization commencing in the water phase.

The ratio of oil phase to water phase can be varied within a wide range. The ratio is generally 10:1 to 1:10, preferably 5:1 to 1:5.

The penflufen-containing polymer particles are then mixed in general with the copper compounds and the alkanolamines to give the biocidal mixtures of the invention. It is, however, likewise possible for the copper compounds first to be mixed with the alkanolamines and then added to the penflufen-containing polymer particles, with the biocidal mixtures of the invention being produced in that way. Preference is given to adding solvent to the alkanolamines and/or to the copper compounds. A preferred solvent used is water. Preferably, first of all the copper compounds are mixed with the alkanolamines and, where used, the solvent, and that mixture is then added to the penflufen-containing polymer particles. When the copper compounds are mixed with the alkanolamines, copper-alkanolamine complexes are formed. These complexes may be produced separately or else employed in situ without further isolation.

The copper-alkanolamine complex commonly comprises a water-soluble alkanolamine. Suitable copper-alkanolamine complexes include ethanolamine-copper complexes, diethanolamine-copper complexes, triethanolamine-copper complexes, and any combination of any of the above.

The molar ratio of the copper compounds to penflufen may be varied within a wide range. Generally speaking, copper is used in excess. The molar ratio of the copper compounds to penflufen is preferably in a range from 150:1 to 2:1. More preferably the molar ratio is between 120:1 and 3:1 and with very particular preference between 90:1 and 5:1.

The molar ratio of the alkanolamines to penflufen can be varied within a wide range. The molar ratio of alkanolamines to penflufen is preferably in a range from 600:1 to 8:1. More preferably the molar ratio of alkanolamines to penflufen is between 480:1 and 15:1 and with very particular preference between 360:1 and 20:1.

The molar ratio of alkanolamines to copper may be varied within a wide range. The molar ratio of alkanolamines to copper is preferably in a range from 10:1 to 1:1. The molar ratio of alkanolamines to copper is more preferably between 8:1 and 2:1.

The molar ratio of copper to penflufen can be varied within a wide range. In general, copper is used in excess. The molar ratio of copper to penflufen is preferably in a range from 600:1 to 8:1. The molar ratio of copper to penflufen is more preferably between 600:1 and 20:1 and with very particular preference between 600:1 and 40:1.

The biocidal mixtures of the invention may be converted to wood preservatives by addition of further auxiliaries, such as solvents and diluents, antioxidants, radical scavengers, UV stabilizers, such as UV absorbers and chelating agents, defoamers, and also further biocides, thickeners and in-container preservatives, or else may be used directly without further addition of these ingredients. It is preferable for solvents and diluents to be added to the biocidal mixtures of the invention and optionally then for thickeners, defoamers, further biocides and in-container preservatives to be added.

Useful solvents and diluents essentially include the following: aromatics, such as xylene, toluene or alkylnaphthalenes, chlorinated aromatics or chlorinated aliphatic hydrocarbons such as chlorobenzenes or chloroethylenes, aliphatic hydrocarbons, such as cyclohexane or paraffins, for example petroleum fractions, alcohols, such as butanol or glycol and also their ethers and esters, and also water.

Examples of thickeners used are polysaccharides, xanthan gum, sodium or magnesium silicates, heteropolysaccharides, alginates, carboxymethylcellulose, gum arabic or polyacrylic acids. A preferred thickener used is xanthan gum.

In-container preservatives used are—for example and preferably—biocides, bactericides and fungicides.

Defoamers used may in general be interface-active substances which are only weakly soluble in the surfactant solution. Preferred defoamers are those which derive from natural fats and oils, petroleum derivatives or silicone fluids.

The wood preservatives of the invention could also be colored. Dyes used may be inorganic pigments, such as iron oxide, titanium oxide and Prussian Blue, and organic dyes such as alizarin dyes, azo dyes and metal phthalocyanine dyes, and trace nutrients, such as salts of iron, manganese, boron, copper, cobalt, molybdenum and zinc.

The wood preservatives of the invention generally contain between 0.05 and 20 percent by weight of penflufen-containing polymer particles, based on the total amount of wood preservative used, preferably between 0.2 and 5 percent by weight. The wood preservatives of the invention generally contain between 0.2 and 50 mol percent of copper, based on the total amount of wood preservative used, preferably between 1 and 20 mol percent.

The wood preservatives of the invention may further comprise additional biocides or auxiliaries such as activity boosters. If triazoles are used as biocides, the amount of these triazoles is generally less than 3.5% by weight, based on the total amount of wood preservative used. The amount of triazoles used, if triazoles are employed as biocides, is preferably between 0.01% by weight and 3% by weight. The amount of the triazoles is more preferably less than 0.01% by weight, based on the total amount of wood preservative used.

The wood preservatives of the invention may likewise be provided in the form of concentrates.

For wood treatment, the concentrate may be diluted to a concentration range from approximately 0.02% to approximately 50%. Forms of the composition diluted for use typically comprise a biocidally effective amount of copper-alkanolamine complex and penflufen-containing polymer particles. Diluted forms for use preferably comprise approximately 0.1 to approximately 2.0% by weight of the above-stated concentrates.

The biocidal mixture of the invention and/or the wood preservative may be applied by known wood treatment techniques, including, but not limited to, brushing on, dipping, drenching vacuum impregnating (e.g. double vacuum technology) and pressure treatment using different cycles.

Also encompassed by the invention is the use of the biocidal mixtures and wood preservatives for the protection of wood, wood products and wood-plastic composites against microorganisms.

Microorganisms which may bring about degradation in or alteration of wood, wood products and wood-plastic composites include, for example, bacteria, fungi, yeasts, algae and slime organisms. Penflufen is active preferably against fungi, especially molds, wood-discoloring and wood-destroying fungi (Basidiomycetes), and against slime organisms and algae. It has further been found that the penflufen-containing microcapsules and wood preservatives of the invention exhibit outstanding protection of the wood with respect to wood-destroying fungi (Basidiomycetes).

Examples include microorganisms of the following genera:

Altemaria, such as Altemaria tenuis,

Aspergillus such as Aspergillus niger,

Chaetomium such as Chaetomium globosum,

Coniophora such as Coniophora puetana,

Fomitopsis, such as Fomitopsis palustris,

Gloeophyllum, such as Gloeophyllum trabeum,

Lentinus such as Lentinus tigrinus,

Poria, such as Poria placenta,

Penicillium such as Penicillium glaucum,

Polyporus such as Polyporus versicolor,

Aureobasidium such as Aurcobasidium pullulans,

Sclerophoma such as Sclerophoma pityophila,

Stereum, such as Stereum sanguinolentum,

Trichoderma such as Trichoderma viride,

Escherichia such as Escherichia coli,

Pseudomonas such as Pseudomonas aeruginosa, and

Staphylococcus such as Staphylococcus aureus.

By way of example and by way of preference, the following may be mentioned as wood-destroying Basidiomycetes capable of effecting degradation or modification of wood and wood-comprising materials:

Coniophora such as Coniophora puteana,

Lentinus, such as Lentinus tigrinus, Antrodia, such as Antrodia sinuosa,

Polyporus such as Polyporus versicolor,

Gloeophyllum, such as Gloeophyllum trabeum,

Fomitopsis, such as Fomitopsis palustris.

Poria, such as Poria placenta,

Stereum, such as Stereum sanguinolentum.

The invention therefore also encompasses the use of the biocidal mixtures and wood preservatives of the invention for protecting wood, wood products and wood-plastic composites against destruction by wood-destroying Basidiomycetes.

Very particularly preferably the biocidal mixtures and the wood preservatives are active against species of the genera Gloeophyllum, Coniophora, Coriolus, Stereum or Poria. More preferably still, the biocidal mixtures are active against species of the genera Coniphora or Poria, more particularly against Poria placenta and Coniphora puteana. More preferable still is the use of biocidal mixtures and penflufen-containing wood preservatives for protecting wood against Poria placenta.

Wood, woodbase materials and wood-plastic composites which can be protected by the biocidal mixtures and wood preservatives of the invention are understood, by way of example, as follows: construction timber, wood beams, railway sleepers, bridge components, jetties, wooden vehicles, crates, pallets, containers, telephone poles, wood paneling, wooden windows and doors, plywood, medium density fiberboard (MDF), chipboard, oriented strand board (OSB), wafer board, laminated veneer lumber (LVL), or wood products used very generally in homebuilding or in construction joinery, and also wood-plastic composites. Preference is given to the protection of wood and solid wood.

The biocidal mixtures and wood preservatives of the invention have an excellent capacity to penetrate the wood or wood product and to thereby act efficiently. Moreover, they display an improved activity against wood-destroying microorganisms in comparison to unencapsulated penflufen, in the presence of copper compounds and alkanolamines.

### EXAMPLES

### Example 1

1.1 Production of the Penflufen-Containing Polymer Particle

A solution of 2.88 g of SDS (Na dodecyl sulfate), 0.163 g of sodium hydrogencarbonate in 200 g of water is admixed with an organic solution consisting of 91.7 g of methyl methacrylate, 4.3 g of penflufen, 3.84 g of hexadecane and 1.63 g of 2,2′-azobis(2-methylbutyronitrile) and is treated by means of a continuous Ultraturrax (IKA T 25 digital/fitted with DK 25.11; 14 000 rpm) for 30 minutes in order to produce an emulsion. This emulsion is subsequently transferred to a 1000 ml three-neck flask, where it is washed with N₂ and heated slowly with stirring to 70° C. It is thereafter stirred at this temperature for 15 hours. After cooling, a low-viscosity, whitish suspension is obtained which has a penflufen content of 1.56% (HPLC).

Average particle size (measured by laser diffraction) 0.153 μm; 90% of the particles (vol %) are smaller than 0.382 μm.

1.2 Production of the Penflufen Solution for the Comparative Experiment

7.5 g of penflufen are dissolved with stirring in a mixture of 232.5 g of Genagen 4296 (N,N-dimethyl-fatty acid amide/CAS No. 14433-76-2) and 260 g of Emulan EL (ethoxylated castor oil). The solution contains 1.5% by weight of penflufen.

1.3 Preparation of the Copper-Ethanolamine Complex

An aqueous solution of copper-ethanolamine was prepared by dissolving 455.25 g of copper carbonate/hydroxide (also known as basic copper carbonate) in 959.00 g of ethanolamine and 1085.75 g of water and stirring. The copper content is 10% by weight.

1.4 Production of the Mixtures of Penflufen Plus Copper-Ethanolamine Complex Investigated in Example 2

The copper-ethanolamine complex from example 1.3 is introduced into a conical flask in an amount leading to the copper/penflufen amount-by-weight ratios employed in table 1. With continual stirring, on a magnetic stirrer, the required amount of penflufen solution from example 1.2 or, respectively, the required amount of penflufen-containing polymer from example 1.1 is slowly added, and stirring is continued for 3 hours.

TABLE 1
(composition of the active ingredient solutions used in example 2)

| | | | | Penflufen |
|---|---|---|---|---|
| | | Copper- | Penflufen- | solution |
| | | ethanolamine | containing | (from |
| | | complex | polymer | example |
| | | (from | (from | 1.2 |
| | | example | example | (comparative |
| Active ingredient | Number | 1.3) | 1.1) | experiment)) |
| Cu + penflufen | JJT | 85.6% | | 14.4% |
| (40:1) | 6646 | by weight | | by weight |
| Cu + penflufen in | JJT | 86.5% | 13.5% | |
| polymer (40:1) | 6648 | by weight | by weight | |
| Cu + penflufen | JJT | 93.7% | | 6.3% |
| (100:1) | 6647 | by weight | | by weight |
| Cu + penflufen in | JJT | 94.1% | 5.9% | |
| polymer (100:1) | 6649 | by weight | by weight | |

### Example 2

The activity of the penflufen-containing polymer particles in the mixture with copper was determined in accordance with DIN EN 113. The test reference used was a mixture of penflufen and copper.

For this, test specimens measuring 25×15×4 mm of wood species Pinus sylvestris and Fagus sylvatica were vacuum-impregnated with 0.04 to 0.4% strength aqueous solutions of active ingredient (copper and penflufen) and conditioned for 14 days. The amount of the active ingredients per kg/m³ in the treated test specimens was measured and is set out in tables A to D. After 14 days, the test specimens on an agar medium were inoculated with a fungal spore suspension in accordance with DIN EN 113. After a further 10 or 11 weeks of incubation, a determination was made of the average weight loss of the wooden test specimens.

TABLE A
(Test fungus: Coniophora puteana; wood: Pinus sylvestris)

| | | Amount | Average |
|---|---|---|---|
| | | of active | weight |
| | | ingredient | loss of |
| | | in wood | wood |
| Active ingredients | Number | [kg/m³] | [%] |
| Cu + penflufen | JJT | 0.32 | 3.7 |
| (40:1) | 6646 | | |
| Cu + penflufen | JJT | 0.46 | 1.6 |
| (40:1) | 6646 | | |
| Cu + penflufen in | JJT | 0.32 | 0.6 |
| polymer (40:1) | 6648 | | |
| Cu + penflufen in | JJT | 0.46 | 0.3 |
| polymer (40:1) | 6648 | | |
| Cu + penflufen | JJT | 0.51 | 17.5 |
| (100:1) | 6647 | | |
| Cu + penflufen | JJT | 0.71 | 3.4 |
| (100:1) | 6647 | | |
| Cu + penflufen in | JJT | 0.51 | 2.7 |
| polymer (100:1) | 6649 | | |
| Cu + penflufen in | JJT | 0.71 | 0.5 |
| polymer (100:1) | 6649 | | |

TABLE B
(Test fungus: Poria placenta; wood: Pinus sylvestris)

| | | Amount of | Average |
|---|---|---|---|
| | | active | weight |
| | | ingredient | loss |
| | | in wood | of wood |
| Active ingredients | Number | [kg/m³] | [%] |
| Cu + penflufen | JJT | 0.32 | 27 |
| (40:1) | 6646 | | |
| Cu + penflufen | JJT | 0.46 | 9.5 |
| (40:1) | 6646 | | |
| Cu + penflufen in | JJT | 0.32 | 5.6 |
| polymer (40:1) | 6648 | | |
| Cu + penflufen in | JJT | 0.46 | 1.9 |
| polymer (40:1) | 6648 | | |
| Cu + penflufen | JJT | 0.51 | 50 |
| (100:1) | 6647 | | |
| Cu + penflufen | JJT | 0.71 | 41 |
| (100:1) | 6647 | | |
| Cu + penflufen in | JJT | 0.51 | 3.8 |
| polymer (100:1) | 6649 | | |
| Cu + penflufen in | JJT | 0.71 | 0.2 |
| polymer (100:1) | 6649 | | |

TABLE C
(Test fungus: Gloeophyllum trabeum;
wood: Pinus sylvestris)

| | | Amount | Average |
|---|---|---|---|
| | | of active | weight |
| | | ingredient | loss of |
| | | in wood | wood |
| Active ingredients | Number | [kg/m³] | [%] |
| Cu + penflufen | JJT | 0.32 | 4.0 |
| (40:1) | 6646 | | |
| Cu + penflufen | JJT | 0.46 | 1.2 |
| (40:1) | 6646 | | |
| Cu + penflufen in | JJT | 0.32 | 0.2 |
| polymer (40:1) | 6648 | | |
| Cu + penflufen in | JJT | 0.46 | 0.1 |
| polymer (40:1) | 6648 | | |
| Cu + penflufen | JJT | 0.51 | 4.4 |
| (100:1) | 6647 | | |
| Cu + penflufen | JJT | 0.71 | 0.6 |
| (100:1) | 6647 | | |
| Cu + penflufen in | JJT | 0.51 | 1.3 |
| polymer (100:1) | 6649 | | |
| Cu + penflufen in | JJT | 0.71 | 0.6 |
| polymer (100:1) | 6649 | | |

TABLE D
(Test fungus: Coriolus versicolor; wood:
Fagus sylvatica (beech))

| | | Amount | Average |
|---|---|---|---|
| | | of active | weight |
| | | ingredient | loss of |
| | | in wood | wood |
| Active ingredients | Number | [kg/m³] | [%] |
| Cu + penflufen (40:1) | JJT 6646 | 0.32 | 3.4 |
| Cu + penflufen (40:1) | JJT 6646 | 0.46 | 1.0 |
| Cu + penflufen in polymer (40:1) | JJT 6648 | 0.32 | 0.2 |
| Cu + penflufen in polymer (40:1) | JJT 6648 | 0.46 | 0.1 |
| Cu + penflufen (100:1) | JJT 6647 | 0.51 | 6.5 |
| Cu + penflufen (100:1) | JJT 6647 | 0.71 | 2.2 |
| Cu + penflufen in polymer (100:1) | JJT 6649 | 0.51 | 0.3 |
| Cu + penflufen in polymer (100:1) | JJT 6649 | 0.71 | 0.3 |

Surprisingly, the average weight loss of wood for mixtures which comprise penflufen and polymer and copper as active ingredients is much smaller in comparison to mixtures where penflufen and copper have been used, in other words those in which at least part of the penflufen has not been protected by the polymer.

1. A biocidal mixture comprising:
penflufen-containing polymer particles,
at least one alkanolamine selected from the group consisting of monoalkylmonoamines, monoalkyldiamines, dialkylamines and trialkylamines, substituted by one, two or three hydroxyl groups, and
at least one copper compound or copper complexes of the alkanolamine.

2. The biocidal mixture as claimed in claim 1, wherein the penflufen-containing polymer particles comprise at least one styrene polymer, styrene copolymer, acrylic polymer or acrylic copolymer.

3. The biocidal mixture as claimed in claim 1, wherein the penflufen-containing polymer particles comprise at least one polyalkyl acrylate, polyalkyl methacrylates, or copolymers of alkyl acrylates and alkyl methacrylates.

4. The biocidal mixture as claimed in claim 1, wherein the penflufen-containing polymer particles are produced by radical oil-in-water emulsion polymerization wherein at least one ethylenically unsaturated monomer is polymerized in the presence of penflufen or its salts and acid addition compounds and in the presence of a radical initiator.

5. The biocidal mixture as claimed in claim 4, wherein the ethylenically unsaturated monomers are styrene, divinylbenzene, C₁-C₂₀ alkyl acrylates, C₁-C₁₈ alkyl methacrylates, or mixtures of these monomers.

6. The biocidal mixture as claimed in claim 1, wherein the copper compounds comprise water-soluble inorganic copper compounds.

7. The biocidal mixture as claimed in claim 1, wherein the copper compounds comprise copper sulfate, copper acetate, copper carbonate, copper hydroxide, copper borate, copper fluoride, copper oxide, copper chloride, copper hydroxide carbonate, or mixtures of these compounds.

8. The biocidal mixture as claimed in claim 1, wherein the alkanolamines comprise C₁-C₈ monoalkylmonoamines, C₁-C₈ monoalkyldiamines, or secondary C₁-C₈ dialkylamines substituted by one or two hydroxyl groups.

9. The biocidal mixture as claimed in claim 1, wherein the alkanolamines comprise isopropanolamine, 1,1- and 1,2-diaminoethanol, aminoethylethanolamine, diethanolamine, triethanolamine, methylethanolamine, monoethanolamine, or mixtures of these compounds.

10. The biocidal mixture as claimed in claim 1, wherein the molar amount of copper compounds used, based on the molar amount of penflufen in the penflufen-containing polymer particles, is 90:1 to 10:1.

11. The biocidal mixture as claimed in claim 1, wherein the amount of penflufen, based on the total amount of the penflufen-containing polymer particles, is 0.5% by weight to 15% by weight.

12. A wood preservative comprising biocidal mixtures as claimed in claim 1 and at least one solvent or diluent, and also optionally thickeners, optionally defoamers, optionally in-container preservatives, and optionally further biocides.

13. A method of protecting wood, wood products or wood-plastic composites against infestation and/or destruction by microorganisms, the method comprising contacting the wood, wood products or wood-plastic composites with the mixture as claimed in claim 1.

14. The method as claimed in claim 13, wherein the contacting comprises brushing, dipping, drenching, vacuum impregnating, pressure treatment, and combinations thereof.

15. A wood, woodbase material or wood-plastic composite comprising the biocidal mixture as claimed in claim 1.

16. The biocidal mixture as claimed in claim 1, wherein:
the penflufen-containing polymer particles comprise at least one styrene polymer, styrene copolymer, acrylic polymer or acrylic copolymer;
the copper compounds comprise water-soluble inorganic copper compounds;
the alkanolamines comprise C₁-C₈ monoalkylmonoamines, C₁-C₈ monoalkyldiamines, or secondary C₁-C₈ dialkylamines substituted by one or two hydroxyl groups.

17. The biocidal mixture as claimed in claim 16, wherein:
the amount of penflufen, based on the total amount of the penflufen-containing polymer particles, is 0.1% by weight to 30% by weight;
the molar ratio of alkanolamines to penflufen is 600:1 to 8:1; and
the molar amount of copper compounds, based on the molar amount of penflufen in the penflufen-containing polymer particles, is 150:1 to 2:1.

18. The biocidal mixture as claimed in claim 17, wherein:
the amount of penflufen, based on the total amount of the penflufen-containing polymer particles, is 0.5% by weight to 15% by weight;
the molar ratio of alkanolamines to penflufen is 360:1 to 40:1; and
the molar amount of copper compounds, based on the molar amount of penflufen in the penflufen-containing polymer particles, is 90:1 to 10:1.

19. The biocidal mixture as claimed in claim 18, wherein:
the penflufen-containing polymer particles comprise at least one polyalkyl acrylate, polyalkyl methacrylates, or copolymers of alkyl acrylates and alkyl methacrylates;
the copper compounds comprise copper sulfate, copper acetate, copper carbonate, copper hydroxide, copper borate, copper fluoride, copper oxide, copper chloride, copper hydroxide carbonate, or mixtures of these compounds; and
the alkanolamines comprise isopropanolamine, 1,1- and 1,2-diaminoethanol, aminoethylethanolamine, diethanolamine, triethanolamine, methylethanolamine, monoethanolamine, or mixtures of these compounds.
